(19) United States
(12) Patent Application Publication
(10) Pub. No.: US 2024/0289875 A1
(43) Pub. Date: Aug. 29, 2024

(54) FANTASY CARAGE

(71) Applicant: Gregory D. Wayne, San Tan Valley, AZ (US)

(72) Inventor: Gregory D. Wayne, San Tan Valley, AZ (US)

(21) Appl. No.: 18/586,282

(22) Filed: Feb. 23, 2024

Related U.S. Application Data
(60) Provisional application No. 63/447,709, filed on Feb. 23, 2023.

(51) Int. Cl. G06Q 30/08; G06Q 30/0207

(52) U.S. Cl. CPC G06Q 30/08; G06Q 30/0207

(57) ABSTRACT

One or more techniques and/or systems are disclosed for performing a virtual auction including receiving user inputs corresponding to a vehicle, wherein the user inputs indicate a vehicle associated with an online auction and a predicted final price for the vehicle at the online auction. The virtual auction data is tracked to compare the final sale price of the vehicle at the online auction to the predicted final price for the vehicle at the online auction. Virtual rewards are generated in response to determining that the difference between the final sale price and predicted final price satisfies one or more virtual auction rules. A virtual vehicle corresponding to the user selected vehicle is moved into a virtual garage and displayed on a user interface of a user device.

### CROSS-REFERENCE TO RELATED APPLICATIONS

This non-provisional application claims the benefit of and priority to U.S. Provisional Application No. 63/447,709 filed Feb. 23, 2023, entitled “Fantasy Carage”. The entire disclosure of the prior application is hereby incorporated by reference herein in its entirety.

### BACKGROUND

The statements in this section merely provide background information related to the present disclosure and may not constitute prior art.

Virtual games, including fantasy type games, have experienced growing popularity across different areas, such as sports, entertainment, etc. These games allow users to simulate real-world activities and experiences that provide entertainment and educational value. However, the characteristics of elements within these games often remain unchanged after the initial creation (e.g., are associated with an initial value or range of values). As such, these games can lack the real-world feel and dynamics of certain events, such as auctions where bidding and price changes can vary, which is not captured or integrated within the games. For example, the value of a car for sale in these games remains fixed or is not based on real-time auction data.

The present disclosure addresses these and other issues related to the lack of incorporation of dynamic real-world changes into the gaming environment.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a computer-implemented method for performing a virtual auction comprises receiving one or more user inputs corresponding to a vehicle from a user, wherein the one or more user inputs indicate a user selection of a vehicle associated with an online auction and a predicted final price for the vehicle at the online auction. The computer-implemented method further comprises storing the received one or more user inputs as virtual auction data and tracking the virtual auction data during the online auction to identify a final sale price of the vehicle at the online auction. The computer-implemented method also comprises comparing the final sale price of the vehicle at the online auction to the predicted final price for the vehicle at the online auction to determine whether a difference between the final sale price and predicted final price satisfies one or more virtual auction rules. The computer-implemented method additionally comprises generating one or more virtual rewards in response to determining that the difference between the final sale price and predicted final price satisfies the one or more virtual auction rules. The computer-implemented method also comprises causing a virtual vehicle corresponding to the user selected vehicle to be moved into a virtual garage and to be displayed on a user interface of a user device.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram illustrating an overall system according to an implementation;

FIG. 2 is a block diagram illustrating one or more components of a system according to an implementation;

FIG. 3 is a block diagram illustrating a game engine according to an implementation;

FIG. 4 illustrates a table storing data according to an implementation;

FIG. 5 illustrates a user interface according to an implementation;

FIG. 6 is a flowchart illustrating a process flow according to an implementation; and

FIG. 7 is a diagram illustrating a process flow according to various implementations.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein may be suitable for use in a gaming environment in which end users can play individually or form a league and pick virtual vehicles to bid during a virtual gaming auction using a virtual coin/currency, wherein the virtual vehicles being bid on through the virtual gaming auction are associated with real vehicles in a live online auction. In various examples, end users can build a “fantasy garage” (Fantasy Carage) from the vehicles purchased from the virtual gaming auction and also vote for favorite vehicles among other league members. In some examples, one end user is designated as the winner at the end of the season, which can be based on one or more criteria, such as, but not limited to: end user virtual currency spend, end user virtual currency in the virtual bank, end user garage value, the highest ranking resulting from end user vehicle voting, etc.

In various examples, systems, apparatuses, modules, and/or computing devices are configured to perform the algorithms described herein for generating the virtual auction gaming environment including the virtual garage. It should be noted that one or more examples can be implemented in different applications, such as in different gaming environments. That is, one or more herein described examples can be configured or implemented in different practical applications across many different area and sectors, such as, for example, different types of auctions, different types of online gaming, different types of league play, different types of activities (e.g., different sports, games, etc.), among others.

In some examples, the virtual bidding and identification of the final purchase price in the corresponding live auction interconnect gaming systems and auction systems to generate data for later applications. For example, the insights into the bidding and final prices allow for insights into a practical contact, such as car value assessment or research, is provided by one or more examples that generate gaming data with a relationship to actual auction data for further analysis and action. As a result, a more effective and dynamic method for vehicle auction data management and analysis is provided. In some examples, more efficient and reliable information is thereby provided to the downstream applications or systems, which also results in improved bidding, reporting, scoring, etc., as well as an improved user (e.g., player) experience, such as overall improving the human machine interaction.

Further, by correlating the virtual auction data and real-time auction data, aspects of the disclosure improve the usability of the data and/or the underlying device at least by generating more relevant or complete data, and as such, the functioning of the underlying computing device is thereby improved, which reduces system resource usage. Efficiency is also improved via display of the data, and user interaction performance is also improved via the user interfaces as described herein. This also overall improves the human machine interaction.

In some examples, a website and a platform, including one or more user portals, are provided, that allows access by users having an improved interaction performance. For example, one or more user interfaces described herein provide an improved user experience.

In one or more examples described herein, an online auction interface or auction game for vehicles offers a number of practical applications to various areas, such as within the vehicle industry, the auction industry, and/or the gaming community. One or more features and functionalities described herein provide one or more practical application, such as, (1) entertainment and engagement to players interested in the automotive genre by simulating the experience of participating in car auctions, the game offers a unique and immersive gaming experience for enthusiasts and casual gamers; (2) an educational tool for individuals interested in learning about the dynamics of car auctions, vehicle valuation, and market trends, and that allows players to can gain insights into the factors influencing car prices, such as vehicle condition, rarity, demand, and historical data, thereby enhancing an understanding of the automotive industry; (3) market research that allows, for example, automotive manufacturers, dealerships, and other industry members to leverage the gaming system as a market research tool to gather insights into consumer preferences, purchasing behavior, and trends in the virtual car market, as well as refining product offerings, pricing strategies, and marketing campaigns by analyzing player interactions and auction outcomes; (4) advertising and brand promotion opportunities for automotive brands to advertise products and promote brand awareness within the gaming community, such as through in-game sponsorships, branded vehicles, and virtual dealership partnerships, thereby increasing visibility and reaching a targeted audience of potential customers; (5) monetization through different revenue streams, including, for example, in-game purchases, virtual currency sales, premium memberships, and advertising partnerships, wherein players may enhance the gaming experience by purchasing virtual currency to unlock premium features or expedite progression within the game; (6) community building and social interaction among players through features such as multiplayer modes, leaderboards, and in-game chat functionalities, wherein players can compete in auctions and share their experiences, fostering a sense of belonging within the gaming community; (7) skills development by providing a platform for players to develop and improve a range of skills, including strategic planning, decision-making, negotiation, and financial management, such as by navigating virtual auctions, analyzing market conditions, and competing with other players, to thereby increase cognitive abilities and critical thinking skills; and (8) cross-platform integration wherein the auction game can be integrated with other platforms and services, including social media networks, streaming platforms, and e-commerce websites, to extend reach and functionality, wherein players may share achievements, broadcast gameplay sessions, or even participate in real-world auctions facilitated by partner organizations.

In one or more examples, the system is configured to allow players to engage in the strategy of vehicle auctions in a virtual setting that allows for building virtual car collections and/or earn in-game rewards, such as virtual currency. While traditional car auctions focus primarily on bidding mechanics and vehicle acquisition, one or more examples provide a virtual fantasy-style auction system that enhances player engagement and immersion. In particular, various examples incorporate elements of prediction and speculation into car auction games, offering players the chance to test their judgment and ability in estimating the auction sale price of vehicles and being rewarded based on the accuracy of the estimate. Thus, one or more examples provide a price estimating or guessing mechanism that drives gameplay. That is, a price estimating or guessing mechanism is integrated into a fantasy-style virtual car auction that encourages players to analyze market trends, assess vehicle value, and make informed predictions about auction outcomes in the virtual auction world that are tied to real-time (actual) online bidding. By allowing players to guess the sale price of vehicles before the auction concludes, these games create opportunities for strategic decision-making and competitive gameplay. In some examples, players submit their predictions for the sale price of one or more vehicles before live online auctions begin, earning virtual currency or rewards based on the accuracy of the predictions. Thus, in some aspects, players consider various factors such as vehicle condition, market demand, and competitor behavior when making predictions, adding depth and complexity to the gaming experience. Live car auction data is thereby combined with virtual or fantasy-type gaming using one or more interfaces or portals of various systems described herein.

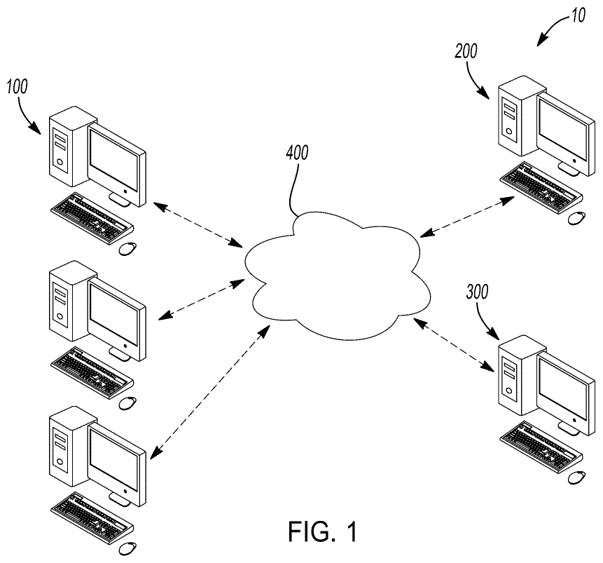

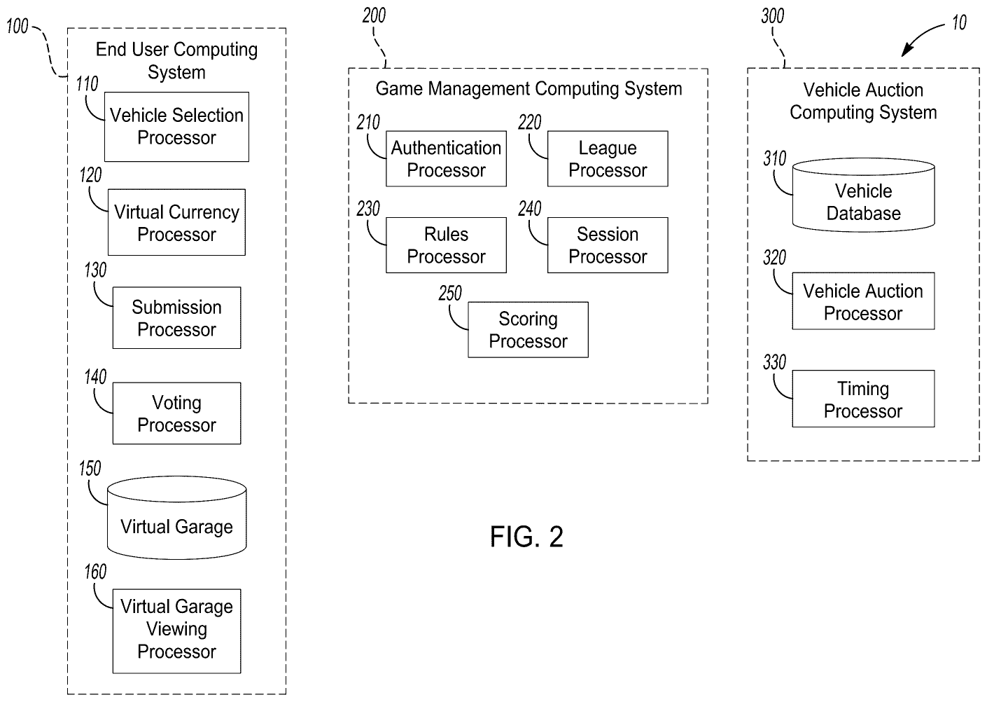

Referring to FIGS. 1 and 2, a system 10 in some examples is configured as a gaming environment having one or more virtual auction components and one or more virtual garage components. In one or more examples, the system 10 is configured to generate a virtual environment (e.g., a virtual gaming environment) that allows user interaction, including allowing players to form a league and during defined time periods (e.g., each week) pick a vehicle to purchase using virtual money. In this way, players are able to build up a fantasy garage of favorite vehicles. In one configuration, each week members of the league vote for a weekly favorite vehicle among the other league members. The winner at the end of the year can be determined through a combination of different factors or measurables, such as the player who has spent all, or nearly all of their money, the player with the highest purchased garage value and the player who has the highest ranking of weekly favorite picks.

As can be seen in FIGS. 1 and 2, the system 10 generally includes a plurality of end user computing systems 100 (e.g., laptop computers, desktop computers, mobile gaming devices, mobile phones, etc.) a game management computing system 200, and a vehicle auction computing system 300. In one form, the end user computing systems 100, the game management computing system 200, and the vehicle auction computing system 300 are communicably coupled via a network 400, which employs a wired and/or wireless communication protocol (e.g., a cellular protocol, a wireless fidelity (Wi-Fi) protocol, among others).

In one implementation, each end user computing system 100 includes a vehicle selection processor 110, a virtual currency processor 120, a submission processor 130, a voting processor 140, a virtual garage 150, and a virtual garage viewing processor 160. The game management computing system 200 may include an authentication processor 210, a league processor 220, a rules processor 230, and a scoring processor 250. The vehicle auction computing system 300 may include a vehicle database 310, a vehicle auction processor 320, and a timing processor 330.

In operation, in some examples, the vehicle database 310 stores vehicles that are associated with a current auction being conducted by the vehicle auction module 320. As an example, the vehicle auction processor 320 executes or interfaces with a web-based vehicle auction software application (e.g., Bring A Trailer® (BaT)), and the vehicle database 310 stores the vehicles, characteristics of the vehicles, and/or pricing information associated with the vehicle (e.g., starting bid, current bid, reserve bid, etc.). Furthermore, the vehicle auction processor 320 may be configured to broadcast the information stored in the vehicle database 310 to the game management computing system 200 and the end user computing systems 100 via a uniquely defined application programming interface (API) when one or more gaming sessions are being executed. The timing processor 330 is configured to provide timing constraints (e.g., a predetermined time period) for the end users to submit vehicle auction price selections and voting selections and is configured to validate selections made within the given time period, such as a 24-hour time period preceding the initiation of a subsequent session.

The authentication processor 210 selectively grants end users access to the system 10 (e.g., gaming environment). As an example, the authentication processor 210 grants access to users that are registered with or subscribed to the vehicle auction computing system 300. It should be understood that the end users may not be registered with the vehicle auction computing system 300 in other forms.

The league processor 220 assigns the end user computing systems 100 either individually or into leagues for implementing sessions of the system 10 (e.g., a first set of users associated with a first set of computing systems 100 are provided in a first league, a second set of users associated with a second set of computing systems 100 are provided in a second league, and so on). The league processor 220 may assign the end user computing systems 100 into the various leagues based on an input received from the end user computing systems 100 or may randomly assign the end user computing systems 100 into the various leagues.

The rules processor 230 is configured to define one or more rules of the gaming sessions executed by the game management computing system 200 and the end user computing systems 100. Table 1 illustrates a non-exhaustive and example list of rules that may be employed by the rules processor 230, and the rules can be implemented in any combination. It should be understood that other rules may be implemented and are not limited to the examples described herein.

| | |
|---|---|
| Rule 1 | Each end user (e.g., player) of the end user computing devices |
| | 100 must be a registered user and/or subscriber of a web-based |
| | or online vehicle auction software application or website |
| | executable by the vehicle auction computing system 300, such as |
| | Bring A Trailer ® or other vehicle auction computing systems (e.g., |
| | having a verified username and password). |
| Rule 2 | The season length is predefined, such as one year, and the season |
| | length may be defined by an administrative user. |
| Rule 3 | Each gaming session is for a predefined period, such as Monday- |
| | Sunday. |
| Rule 4 | Each end user must make a vehicle selection via the vehicle |
| | selection processor 110 in advance of a given gaming session, |
| | such as 11:59 pm PST/PDT on Sunday for the following week |
| | when the length of the gaming session is one week. |
| Rule 5 | End users can submit a vehicle selection via the vehicle selection |
| | processor 110 as soon as the selection becomes available via the |
| | web-based vehicle auction software application executable by the |
| | vehicle auction computing system 300. End Users enter the |
| | selection and corresponding vehicle data via the submission |
| | processor 130 into, for example, a spreadsheet or other text-based |
| | file or a web-based text entry software. In some examples, a portal |
| | or other user interface is configured to receive one or more user |
| | inputs. |
| Rule 6 | End User ‘A’ notifies the league of the selection via the submission |
| | processor 130, such as a group message or any other similar |
| | communication protocol embedded within the system. |
| Rule 7 | The selected vehicle auction must end during the following gaming |
| | session. |
| Rule 8 | After each gaming session, each end user receives a virtual |
| | currency coin via the virtual currency processor 120 to spend on |
| | the weekly selection. As an example, each end user receives |
| | $300,000 for the first week (e.g., when the gaming session is |
| | defined as one week) and $150,000 each week thereafter. Picks |
| | can be made at any time and it is determined at start of the season |
| | if two or more end users are allowed to pick the same vehicle. |
| Rule 9 | The end user's pick along with the estimate of what the winning or |
| | highest bid will be is entered into web-based interface via the |
| | submission processor 130 (e.g., using a spreadsheet type |
| | interface). The submission may include the following information |
| | associated with the vehicle: year, make, model, weblink, auction |
| | end date, and sale price estimate. This information must be |
| | submitted within twenty-four hours of selection in order to avoid |
| | blocking other league members from selecting a vehicle/item. If |
| | end users do not notify the league of the estimate within a |
| | predefined time frame, other end users can ‘steal’ the vehicle pick. |
| | If the other end users do not steal the pick, the end user must |
| | submit the estimate no later than a defined time (e.g., midnight |
| | Sunday). If no estimate is submitted by the following session, it is |
| | treated as a zero (0) estimate and does not qualify for any of the |
| | estimate bonus structure as described in more detail herein. If one |
| | of the end users ‘steals' a pick, end users are allowed to select |
| | another vehicle for the following session along with an estimate in |
| | advance of the following session. |
| Rule 10 | The selections are tracked by the scoring processor 250 and |
| | awarded based on the sales price or highest bid. If the end user |
| | has enough money in their account (as indicated by the virtual |
| | currency processor 120), the end user wins their weekly selection |
| | and the virtual vehicle is stored (e.g., moved) in the end user's |
| | virtual garage 150. An end user receives a bonus for the following |
| | week if the end user's estimate is within a specified percentage of |
| | the sales/high bid price, such as: |
| | exact estimate: $150,000; |
| | within +/−5%: $100,000; |
| | within +/−10%: $75,000; and |
| | within +/−15%: $50,000. |
| | However, other award amounts are contemplated, as well |
| | as for different accuracies or range of accuracies in |
| | prediction. |
| Rule 11 | Any unspent virtual coins as determined by the virtual currency |
| | processor 120 carries over to the following week/session, thereby |
| | enabling end users to accumulate virtual currency and make more |
| | expensive purchases. |
| Rule 12 | If an end user does not have virtual coins stored as determined by |
| | the virtual currency processor 120 to purchase a weekly selection, |
| | the end user forfeits purchasing the vehicle for that gaming |
| | session/week, and the end user receives a penalty, for example, |
| | $100,000 (or other value). As such, the end user does not receive |
| | any estimate bonus, and instead of the $150,000 weekly allotment, |
| | the end user receives a reduced weekly allotment, such as |
| | receiving $50,000 for the next week/session. Vehicles that did not |
| | win that week/session do not qualify for favorite voting as |
| | described herein and are automatically scored a defined value, |
| | such as a ‘10’. |
| Rule 13 | Two or more end users cannot select the same vehicle in a |
| | week/gaming session that is defined by an administrative user, as |
| | described herein. |
| Rule 14 | If an end user's selection of a weekly vehicle is removed from the |
| | vehicle auction computing system 300 through no intervention of |
| | the end user, the vehicle sales price will be indicated as zero ($0) |
| | such that the value of the vehicle is neither added nor subtracted |
| | from the end user's virtual currency account. This allows the end |
| | user to participate in the favorite's voting for the week/session with |
| | the removed vehicle in some examples. |
| Rule 15 | All communication among league members is via the messaging |
| | or other communication protocol defined by the system 10. |
| Rule 16 | Each week, end users select a favorite vehicle by rank order |
| | (1/2/3) via the voting processor 140 based on all other league |
| | member selections. |
| Rule 17 | End users cannot vote via the voting processor 140 for their own |
| | vehicle. |
| Rule 18 | End users vote for three top favorite vehicles and assign a position |
| | 1/2/3 via the voting processor 140. All others will be given a default |
| | value of six (6), and if end users do not win a vehicle that week it |
| | will be assigned a defined value, such as a value of ten (10). |
| Rule 19 | Voting is blocked for any vehicle not won by an end user that |
| | week/session. |
| Rule 21 | The scoring processor 250 is configured to track the voting and |
| | determine a weekly winner based on number of votes received, |
| | including ties, or other defined criteria or factors. |
| Rule 22 | At the end of the season, the scoring processor 250 is configured |
| | to determine a winner, for example, based on a combination of: the |
| | end user who has the least amount or virtual currency in their |
| | account (as determined by the virtual currency processor 120), |
| | meaning the end user was able to spend most or all of the virtual |
| | money earned throughout the course of the year (25%); the end |
| | user with the greatest value of vehicles/items in their virtual garage |
| | 150 (50%); and the end user with the best tally of weekly favorites |
| | as voted by the league members (25%). It should be noted that |
| | other factors and different weights or relative percentages can be |
| | implemented. |

The virtual garage viewing module 160 enables the end users to view one or more vehicles (e.g., a user interface displaying one or more winning vehicles from previous or current sessions) stored in the virtual garage 150 of the respective end user computing system 100 and other end user computing systems 100 associated with other end users. An end user may customize, via the virtual garage viewing processor 160, the appearance of the associated virtual garage 150 by selecting from among a plurality of predefined/embedded garages. As an example, the end user may customize, via the virtual garage viewing processor 160, the appearance of the associated virtual garage 150 such that the virtual garage 150 corresponds to a user's virtual representation of a physical garage, such as the Petersen Museum, the Indianapolis Motor Museum, the Car Vault, or other types of predefined/known vehicle garages.

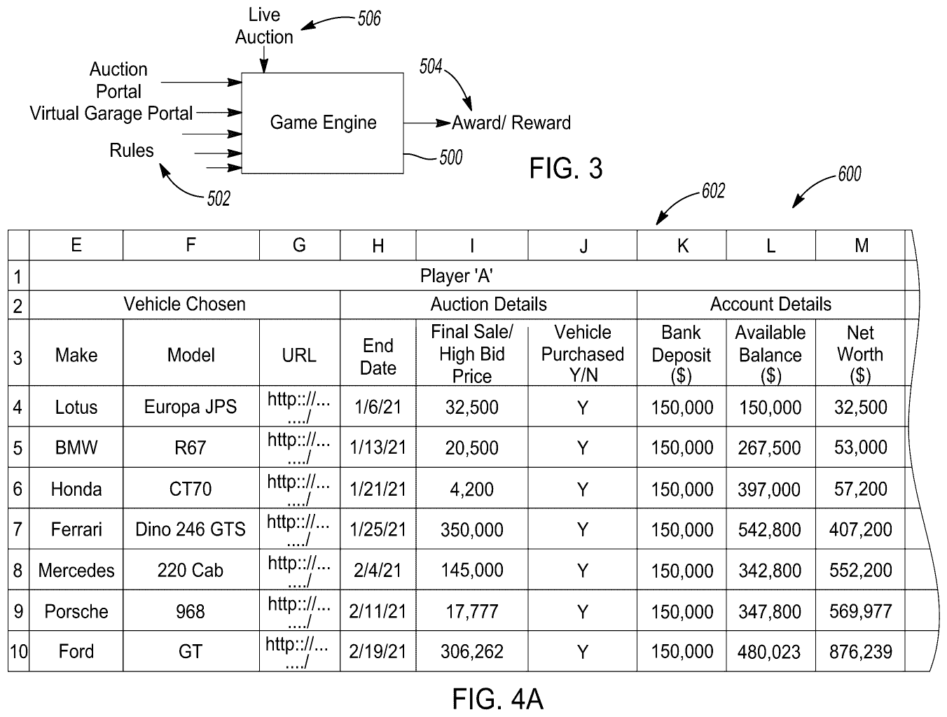

In one or more examples, the system 10 is implemented as or forms part of a game engine 500 (e.g., a gaming processor) as illustrated in FIG. 3. The game engine 500 in various examples is configured as a virtual auction gaming generator that processes one or more received inputs 502 to perform the operations as described in more detail herein. For example, the game engine 500 is configured to receive one or more inputs 502 from end users (e.g., players) via different portals or interfaces, such as an auction portal configured to receive one or more predicted final sale amounts for one or more vehicles, and a virtual garage portal configured to receive one or more parameters relating to a virtual garage of the end user as described in more detail herein. In some examples, the auction portal and the virtual garage portal are user interface displayed on a screen or other display device of the end user computing systems 100. Other inputs 502 are contemplated, such as one or more rules as described in more detail herein. However, other inputs can be provided, such as different elements, requirements, options, etc. for the virtual auction, to define game play, etc. Thus, the illustrated inputs 104 are merely for example, and other inputs can be used by the game engine 500. That is, the game engine 500 can be configured to generate different types of virtual auction and virtual garage environments or game settings.

In operation, the game engine 500 receives the inputs 502, processes the inputs 502 (e.g., end user selections, end user bids, virtual auction rules, league rules, etc.), and generates as an output 504, such as one or more awards or rewards as described herein. For example, the game engine 500 processes the end user inputs and in response to the defined rules, after a defined period (e.g., virtual auction period), generates one or more awards or rewards, such as virtual currency as described in more detail herein. The game engine 500 allows for dynamically generating many different types of outputs, wherein one or more instances of the game engine 500 (including one or more user interfaces as described in more detail herein) can then be run on the end user computing systems 100, which allows interaction thereof by the end user (e.g., game or league player).

In some examples, the game engine 500 can be implemented in software, hardware, or a combination thereof. For example, a series of software packages implementing one or more aspects of the game engine 500 can be provided. In one example, the game engine 500 is configured to generate the output 504 based in part on live auction data 506 received from one or more online or live auctions. That is, the virtual vehicle being bid on by the end users are associated with or correspond to an actual or real auction that is occurring at an online or other vehicle auction. For example, the end user selects a vehicle that is being auctioned at an actual or real auction and the game engine 500 receives the live auction data to track and correlate with the virtual auction to generate the output 504 based in part on the outcome (e.g., final auction selling price) of the live auction corresponding to the live auction data 506 and the rules. It should be appreciated that by using the game engine 500, the virtual auction is thereby made dynamic and associates real-time auction data from one or more auction sources as described in more detail herein. Thus, the game engine 500 is configured to integrate a real-time and/or actual auction components withing the virtual auction gaming environment.

It should also be appreciated that the game engine 500 is not limited to generating specific types of outputs, but can be used to generate outputs for many different applications, such as related to other non-auction or non-vehicle applications. In some examples, the game engine 500 is configured to generate preprogrammed, predefined, or prepopulated spreadsheets, templates, or user interfaces to facilitate the virtual bidding process. In one example, empirical, experimental or simulation data is used to train or configure the game engine 500, and then the inputs 104 are processed to generate the output 504. In some examples, machine learning is used to train or configure the game engine 500 based on a training data from simulations or feedback received from previously generated bids or auctions. In some examples, artificial intelligence (AI) is used as part of the training of and/or processing by the game engine 500 to generate improved virtual bidding and virtual garage implantations.

One particular implementation of the game engine 500 is a processing machine that can be used in combination with one or more other systems (e.g., online vehicle auction systems) to generate the virtual auction and gaming environment and the output 504. More particularly, the game engine 500 includes one or more processors as described herein that are configured as a processing engine that performs operations to generate the virtual auction and gaming environment and the output 504 based on the inputs 502. In some examples, the inputs 502 and/or the outputs 504 are configured to be displayed and manipulated or interacted with as described in more detail herein. It should be noted that the input data 502 can include different types of data configured in different ways corresponding to different types of bids, rules, etc. It should also be noted that the examples described in the present disclosure can be applied to different types of data, including non-bidding data. In some examples, the input data 502 is obtained via one or more user interfaces having selectable or user input elements or fields (e.g., user input fields for the selection of the vehicle, selection of the corresponding online auction, estimated final bid price, etc.). In various examples, manual entry of input data is additionally or optionally performed.

In operation, the game engine 500 has access to the input data 502, such as the different types of inputs and performs one or more operations as described in more detail herein. It should be appreciated that the game engine 500 is configured to perform virtual auction and/or vehicle gaming operations in a wide variety of application domains. For example, the implementations of the present disclosure provide for virtual auction and bid generation and execution in a vehicle auction domain, but various implementations can be used in other domains, such as with other types of auctions.

In some examples, the game engine 500 includes one or more control interfaces is configured to allow interaction with the game engine 500, such as by the end users and/or one or more administrators. For example, the control interface(s) allow for user inputs or other inputs to be received and utilized by the game engine 500 as described in more detail herein. In some examples, the control interface(s) are a gaming interface, a virtual auction interface, a virtual garage interface, etc.

As should be appreciated, various inputs and/or operations can be performed using one or more end user devices, for example, the end user computing systems 100, such as a smart phone, a laptop computer, or other end user computing device, which allow for user input. In some examples, one or more monitoring devices, such as a camera (or other imaging or non-imaging sensor) are configured to acquire information and automatically provide information, which can include the feedback. It should be noted that in some examples, the game engine 500 or components thereof are configured as a downloadable application that can be stored and loaded to one or more of the end user computing systems 100. The end user computing systems 100 is able to use the game engine 500 to generate bids, build the virtual garage, etc. that are associated with participating in, for example, the gaming environment.

In some implementations, the system 10 or the game engine 500 is operable and configured to perform one or more operations to generate the gaming environment that allows for virtual auctions and virtual garages that are associated with data from one or more real or actual online auctions (e.g., an online auction house with daily sales). It should be appreciated that the data received from external sources or systems can be transformed or configured to be complementary to the virtual auction or gaming environments, such as formatted for display on one or more user interfaces as described herein and that shows a relationship between the data, as well as allows for modifications to the displayed data that results in changes to the stored data. In some examples, the system 10 or the game engine 500 is configured to generate a league style play virtual environment, which may be in a daily play format, allows for tracking of a virtual bank of virtual currency, allows for voting for favorite virtual vehicles, allows for selection of the car for bidding on, allows for building up a virtual garage of winning vehicle selections, and stores data in a database of car values and other information that can be used for future research, such as by one or more end users.

In some examples, the system 10 or the game engine 500 is configured to generate a league style play virtual environment as follows (the order of which can be varied):

1. Receive user input from one or more end users (e.g., users who are registered through an auction site (e.g., BaT with a verified username and password) to sign up to play individually or as part of a ‘league’ that includes the virtual auction and virtual garage as generated by the system 10 or the game engine 500. Each league can be comprised from a defined number of players, such as one to twelve (12) players.

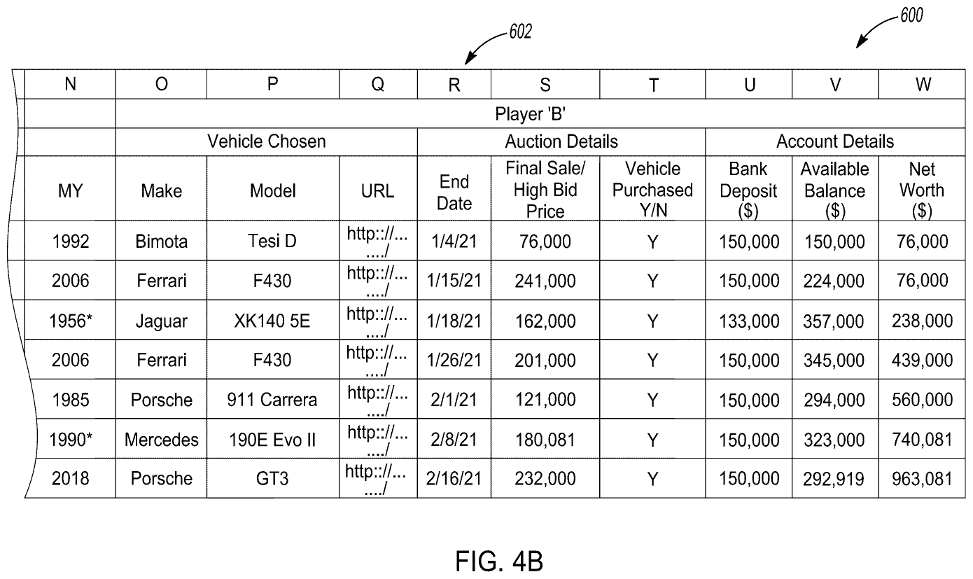

2. Receive a player vehicle selection for the following game period, such as a game as described in more detail herein and stored in a database, such as a table 600 as illustrated in FIG. 4. The table 600 in some examples is sorted or arranged by player 602 and includes a plurality of columns storing data relating to the auction (e.g., details relating to the vehicle selected, auction details relating to the live auction associated with the vehicle details, account details, such as virtual currency, etc., as well as other data as desired or needed). Each week every player receives virtual currency (e.g., virtual BaT coin) to spend on a weekly selection. This amount can vary and can be an agreed upon amount by league members at the initiation of league and input as one or more of the rules. In some examples, players review a daily auction feed and identify favorites each day that form part of a list of favorites that are stored and a user selection (pick) for one vehicle for the week is received. It should be noted that selections can be made at any time and two or more players cannot pick the same vehicle in some examples.

3. Store the picks along with price estimate of the winning or highest bid in a database (e.g., in a table or spreadsheet format). In some examples, the stored data includes year, make, model, weblink, auction end date, and sale price estimate. However, other data can be stored as desired or needed.

4. Track the picks and generates one or more awards based on the sales price or highest bid as described herein. A determination is made if the player has enough money (virtual currency) in their account in response winning the weekly selection, and if there are sufficient funds, the virtual vehicle is moved into the virtual garage of the player (e.g., virtually parked in the virtual garage where the user is able to view displayed images of all the vehicles in his or her virtual garage). A virtual bonus is generated and associated with the player for use the following week if the estimate is within a percentage deviation of the sales/high bid price as described herein. The system 10 or the game engine 500 determines any unspent virtual coin, which is carried over to the following week and allows for accumulation of virtual coin to make larger virtual purchases. If a determination is made by the system 10 or the game engine 500 that the player does not have enough virtual coin in their account to purchase the weekly selection, the system 10 or the game engine 500 identifies this condition as a forfeit purchasing the vehicle that week and the player's account is reduced by the difference in how much the user had available versus the purchase price of their selection. [Example: Player ‘A’ has $200,000 in their account. The player choses a vehicle for the week having Sales Price/High Bid that was $250,000. The player does not ‘win’ this vehicle, it is not added to their virtual garage, and next week the player's weekly allotment is reduced by $50,000 (the difference between $200,000 and $250,000)]. It should be noted that whether two or more players can pick the same vehicle in a week is a defined rule in some examples (e.g., an option to select at the beginning of the season by the league ‘commissioner’).

5. Track each player's weekly selection, the amount the player receives each week, a current available balance and a total worth of the player's garage based on the accumulated value of all the vehicles in their garage. It should be appreciated that other data can be tracked.

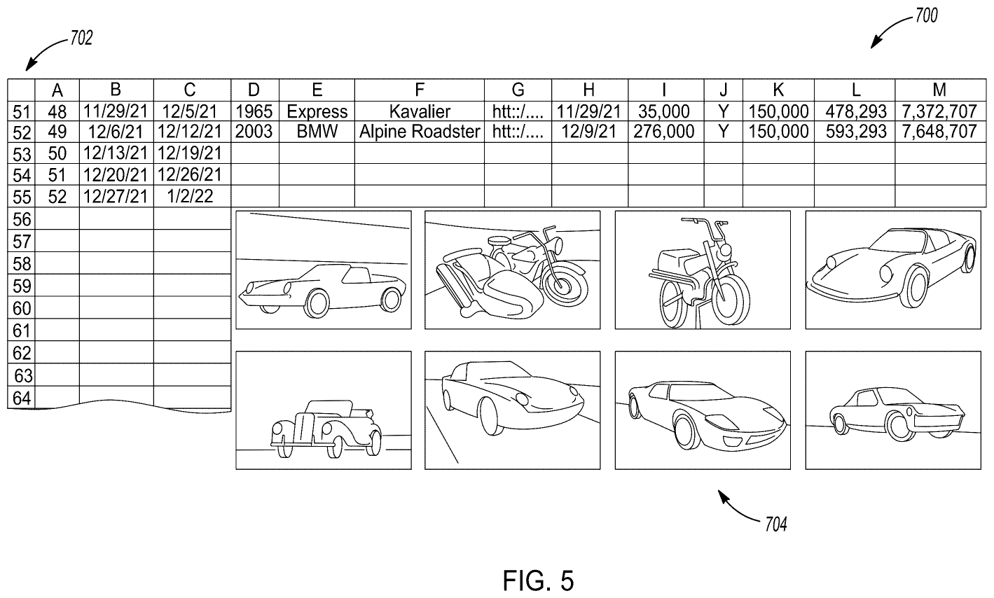

6. Create a virtual garage space for each player that all players in the league can view, such as illustrated by the user interface 700 shown in FIG. 5, which in some examples includes a data portion 702 and an image portion 704. In one example, the virtual garage space is generated to include data in the data portion 702 that is related to the year/make/model of the weekly vehicle, a hyperlink to more information (e.g., to a virtual image or to the actual live auction corresponding to the virtual vehicle), the winning price and an image of the vehicle viewable in the virtual garage in the image portion 704. In the illustrated example, multiple virtual vehicles are associated with and stored within the virtual garage for the player.

7. Provide a communication interface as described herein for league members to communicate with one another.

8. Receive, for example each week, league member selections of favorite vehicles by rank order based on all league members selections as described in more detail herein. A player cannot vote for their own vehicle in some examples. The virtual garage data in some examples tracks the voting and is used to determine a weekly winner based on the number of votes received, including ties.

9. At the end of the session (e.g., end of year), identify one winner (and other placed winners) as described in more detail herein.

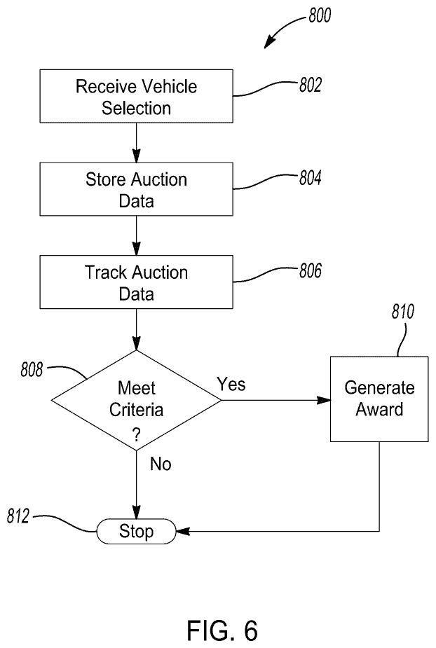

FIG. 6 is a flowchart illustrating an example method 800 for a generating a virtual auction and virtual garage, such as described in more detail herein, and which may be performed, for example, by the system 10 or the game engine 500. At operation 802 a vehicle selection is received from one or more end user, for example, one or more players. The selection in some examples includes a user selection of a vehicle with an estimated or predicted auction sale price as described in more detail herein.

At operation 804, data associated with the auction is stored. For example, price data, sale data, etc. from a live auction associated with the selected vehicle is stored (and updated, for example, periodically as the live auction progresses) as described in more detail herein. The auction data is tracked at operation 806. For example, as described in more detail herein, the real auction data associated with the user vehicle selection and predicted price is tracked.

A determination is made at operation 808 whether one or more criteria relating to the virtual auction are met. For example, a determination is made whether one or more rules as described herein have been satisfied, such as whether the predicted final price is within a range or percentage of the actual final sale price at the associated auction, whether the user has available virtual currency, etc. If a determination is made that one or more of the criteria are met, then at operation 810, an award is generated. For example, as described in more detail herein, the award can be additional virtual currency, the virtual purchase of the vehicle that is then stored in the virtual garage, etc. Thereafter, or if the criteria are not met (e.g., predicted price not within the range or not enough available virtual currency), the method 800 ends at operation 812.

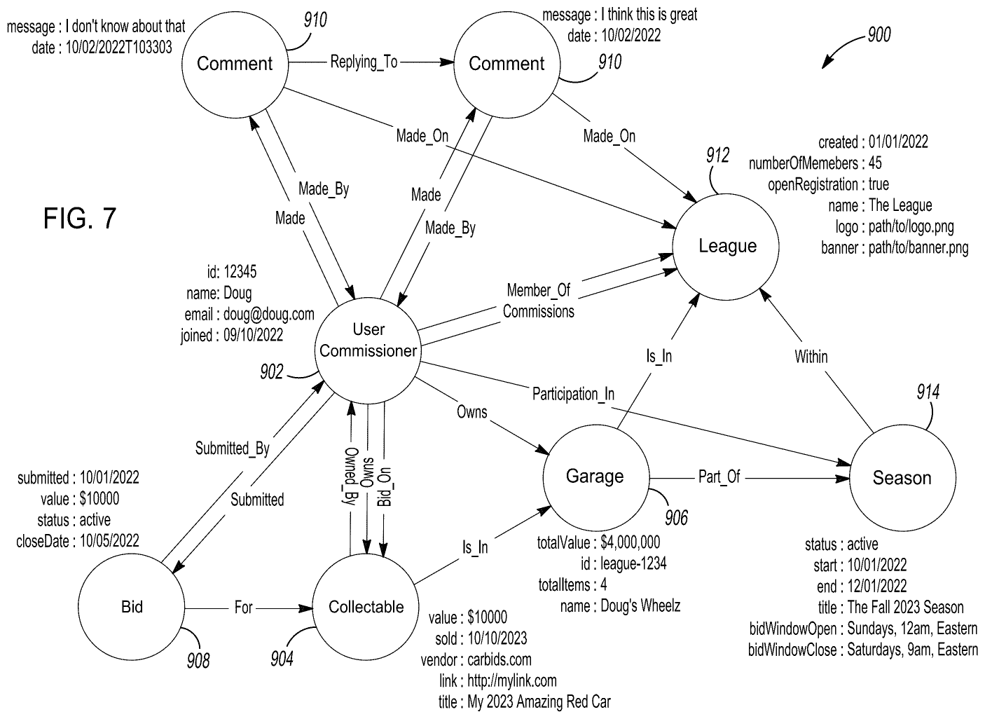

A process flow 900 in various examples is illustrated in FIG. 7. The process flow 900 can be implemented as part of, for example, the system 10 or the game engine 500, or the method 800. It should be appreciated that the process flow 900, as well as one or more examples, can be implemented in a client-server configuration. However, other configurations are contemplated. As can be seen, a user and/or commissioner entity 902 (e.g., user component) is defined and allows for bidding on one or more collectibles 904 (e.g., one or more virtual vehicles) using a bid component 908, which can be stored in a garage component 906, such as configured as the virtual garage 150. The process flow 900 allows for comments 910 between different entities, such as different users or players. The process flow 900 is defined within a league component 912 and having a season component 914 that can be implemented as described in more detail herein. It should be noted that the flow directions and information communicated can be varied, such as based on the application, entities, objects, etc. Additionally, the data associated with and shown in FIG. 7 is merely for example.

In some examples, the process flow 900 corresponds to an application utilizing a graph-based database to store objects and relationships. The database allows flexibility in the relationships between various entities. Thus, FIG. 7 illustrates one example of the relationships and structures corresponding to an implementation of the virtual auction and virtual garage as described herein. It should be noted that the application can be configured using framework (e.g., a SvelteJS web framework, or others, such as React, Vue, Angular). In some examples, a server-side compiled web framework creates highly reactive and interactive front-end sites. In some examples, an overall technical stack is defined by the following:
1. Data is stored in the GraphDB (e.g., Neo4J);
2. One example of an application is built and deployed utilizing a service to deploy web applications (e.g., Amazon Elastic beanstalk services) and to manage application packaging and delivery;
3. Authentication may be provided by a combination of different services (e.g., Auth0 and Amazon Cognition services); and
4. Data storage is provided by an in-memory storage system (e.g., Redis) to store and retrieve user sessions and associated information.

Thus, one or more examples provide a virtual auction or gaming system having a link or association with a live auction that allows for accumulation of virtual currency and virtual cars in a virtual garage based on performance by one or more users.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the forms is described above as having certain features, any one or more of those features described with respect to any form of the disclosure can be implemented in and/or combined with features of any of the other forms, even if that combination is not explicitly described. In other words, the described forms are not mutually exclusive, and permutations of one or more forms with one another remain within the scope of this disclosure.

In this application, including the definitions below, the term ‘module’ or the term ‘algorithm’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used below, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure.

What is claimed is:

1. A computer-implemented method for performing a virtual auction, the computer-implemented method comprising:
receiving one or more user inputs corresponding to a vehicle from a user, the one or more user inputs indication a user selection of a vehicle associated with an online auction and a predicted final price for the vehicle at the online auction;
storing the received one or more user inputs as virtual auction data;
tracking the virtual auction data during the online auction to identify a final sale price of the vehicle at the online auction;
comparing the final sale price of the vehicle at the online auction to the predicted final price for the vehicle at the online auction to determine whether a difference between the final sale price and predicted final price satisfies one or more virtual auction rules;
generating one or more virtual rewards in response to determining that the difference between the final sale price and predicted final price satisfies the one or more virtual auction rules; and
causing a virtual vehicle corresponding to the user selected vehicle to be moved into a virtual garage and to be displayed on a user interface of a user device.

2. The computer-implemented method of claim 1, further comprising updating the virtual garage with additional virtual vehicles in response to determining that the difference between the final sale price and predicted final price satisfies the one or more virtual auction rules in one or more additional auctions.

3. The computer-implemented method of claim 1, wherein the one or more virtual auction rules comprises a percentage differential between the final sale price and predicted final price.

4. The computer-implemented method of claim 3, wherein generating the one or more virtual rewards comprises generating virtual currency that is associated with the user.

5. The computer-implemented method of claim 4, wherein a value of the one or more virtual awards varies based on an amount of the percentage differential between the final sale price and predicted final price.

6. The computer-implemented method of claim 1, further comprising establishing a base virtual currency available to the user.

7. The computer-implemented method of claim 1, causing the virtual vehicle to be blocked from being moved to the virtual garage in response to a stored virtual currency amount for the user being below the final sale price.

8. The computer-implemented method of claim 1, further comprising receiving a user input vote corresponding to one or more favorite vehicles of one or more different users.

9. The computer-implemented method of claim 1, wherein a plurality of users comprises a virtual auction league, and further comprising identifying from the plurality of users, one user as a winner, wherein the winner is based on at least one of an amount of virtual currency spent during a virtual auction session, a virtual garage value, and a ranking based on one or more favorite votes.

10. The computer-implemented method of claim 1, further comprising receiving confirmation that the user is authenticated with one or more online auctions.

11. The computer-implemented method of claim 1, wherein the virtual auction data comprises at least a vehicle year, a vehicle make, a weblink, an auction end date, and a sale price estimate.

12. The computer-implemented method of claim 1, further comprising tracking and storing for each of a plurality of users, one or more user selections, a virtual currency amount received for one or more defined periods, a current available virtual currency balance, a total virtual worth of the virtual garage based on an accumulated value of the virtual vehicles associated with the virtual garage.

13. The computer-implemented method of claim 1, further comprising updating a user interface associated with the virtual garage based at least in part on the one or more user inputs.

14. The computer-implemented method of claim 1, wherein a plurality of users comprises a virtual auction league and further comprising transmitting one or more messages between the plurality of users.

15. A virtual auction system, comprising:
a database storing virtual auction data including at least a user selection of a vehicle associated with an online auction and a predicted final price for the vehicle at the online auction;
at least one processor; and
at least one memory comprising computer-readable instructions, the at least one processor, the at least one memory and the computer-readable instructions configured to cause the at least one processor to:
receive one or more user inputs corresponding to a vehicle from a user, the one or more user inputs indication a user selection of a vehicle associated with an online auction and a predicted final price for the vehicle at the online auction;
store the received one or more user inputs as virtual auction data;
track the virtual auction data during the online auction to identify a final sale price of the vehicle at the online auction;
compare the final sale price of the vehicle at the online auction to the predicted final price for the vehicle at the online auction to determine whether a difference between the final sale price and predicted final price satisfies one or more virtual auction rules;
generate one or more virtual rewards in response to determining that the difference between the final sale price and predicted final price satisfies the one or more virtual auction rules; and
cause a virtual vehicle corresponding to the user selected vehicle to be moved into a virtual garage and to be displayed on a user interface of a user device.

16. A computer storage medium having computer-executable instructions that, upon execution by a processor of a computer, cause the processor to at least:
receive one or more user inputs corresponding to a vehicle from a user, the one or more user inputs indication a user selection of a vehicle associated with an online auction and a predicted final price for the vehicle at the online auction;
store the received one or more user inputs as virtual auction data;
track the virtual auction data during the online auction to identify a final sale price of the vehicle at the online auction;
compare the final sale price of the vehicle at the online auction to the predicted final price for the vehicle at the online auction to determine whether a difference between the final sale price and predicted final price satisfies one or more virtual auction rules;
generate one or more virtual rewards in response to determining that the difference between the final sale price and predicted final price satisfies the one or more virtual auction rules; and
cause a virtual vehicle corresponding to the user selected vehicle to be moved into a virtual garage and to be displayed on a user interface of a user device.
